(19) United States
(12) Patent Application Publication
(10) Pub. No.: US 2023/0018440 A1
(43) Pub. Date: Jan. 19, 2023

(54) REMOVAL APPARATUS FOR ADDITIVE MANUFACTURING BUILD PLATE

(71) Applicant: Sintavia, LLC, Hollywood, FL (US)

(72) Inventors: Ernest Charles Stranz, Hood River, OR (US); Keren Ott Callen, II, Plantation, FL (US); Tristan Keith Peyton, Tamarac, FL (US)

(73) Assignee: Sintavia, LLC, Hollywood, FL (US)

(21) Appl. No.: 17/684,791

(22) Filed: Mar. 2, 2022

Related U.S. Application Data
(60) Provisional application No. 63/223,254, filed on Jul. 19, 2021.

(51) Int. Cl. B22F 12/88; B33Y 40/00; B22F 10/47

(52) U.S. Cl. CPC B22F 12/88; B33Y 40/00; B22F 10/47

(57) ABSTRACT

A removal apparatus for aiding in the removal of an additive manufacturing build plate from a support structure is provided. The removal apparatus may include a plurality of printed geometries disposed proximate one or more fasteners securing or anchoring the build plate to the support structure. The printed geometries may be printed concurrently with the additive manufacturing article. The apparatus may further include one or more expansion bolts sized for installation between a pair of printed geometries positioned apart from one another. The expansion bolts may include a small lead screw, a large lead screw and a coupling nut. In operation, rotation of the coupling nut in a first direction lengthens the expansion bolt to push the printed geometry outward thereby reducing the distortion in the build plate so that the fastener between the build plate and the support structure may be removed.

### CROSS-REFERENCE TO RELATED APPLICATION

The present application claims the benefit of priority to U.S. Provisional Patent Application No. 63/223,254, filed on Jul. 19, 2021, the disclosure of which is hereby incorporated by reference in its entirety and is made part of the present U.S. utility patent application for all purposes.

### FIELD OF THE DISCLOSURE

The present invention relates to the removal of warped or bowed build plates of an additive manufacturing system.

### BACKGROUND OF THE DISCLOSURE

Additive manufacturing is a process by which a metal article of manufacture is formed by a layer-by-layer construction. Generally, a liquid or metal, often a metal powder, is applied to a work surface and the liquid or metal is subjected to one or more of a sintering, curing, melting or a similar process The process is repeated to provide the finished part. Specifically, additive manufacturing is utilized to build a wide variety of articles of manufacture (i.e., work or build pieces) having various geometric shapes of varying complexity. These work or build pieces are typically printed via a three-dimensional (3-D) printer using computer hardware and software and various metal powders. There are a number of different additive manufacturing techniques. For example, one system utilizes laser powder bed fusion (LPBF) in which one or more lasers fuse metal powder particles together layer-by-layer. After each layer of the part is built on a build plate, another layer of powder is deposited onto the previous layer, which is subsequently fused by the laser. After multiple layers are printed, the resulting part is then cut from the build plate.

The build plate is subjected to rapid heating, solidification (i.e., welding or fusing) of the metal powder on the build plate and the weight of the finished part. Thus, the build plate is often mounted to a support structure (e.g., subplate or the like) in order to provide support for the weight of the part and to dissipate heat. The build plate is often subjected to depowdering, heat treatment and planed down to being flat after each use. Over time the build plate tends to distort, namely it bows or warps because of the heat of the additive manufacturing process and the weight of the article being built. After multiple uses the build plate may need to be removed from the support structure so that the part being manufactured is not adversely affected because of the build plate not being flat and to ensure the build plate is zeroed properly to the coordinate system of the 3-D printer. The inherent problem is that because the build plate and the support structure are anchored or bolted together, removing the bolts when the build plate is warped or bowed may potentially be difficult and may result in damage to the build plate, support structure and/or the additive manufacturing system.

Thus, there is a need for a way to safely and efficiently remove distorted build plates from the support structure of an additive manufacturing system.

### SUMMARY OF THE DISCLOSURE

In one aspect, a removal apparatus for aiding in the removal of an additive manufacturing build plate from a support structure is provided. The removal apparatus may include a plurality of printed geometries disposed proximate one or more fasteners securing or anchoring the build plate to the support structure. In one embodiment, the printed geometries may be printed concurrently with the additive manufacturing article. The apparatus may further include one or more expansion bolts sized for installation between a pair of printed geometries positioned apart from one another. The expansion bolts may include a small lead screw, a large lead screw and a coupling nut. In operation, rotation of the coupling nut in a first direction lengthens the expansion bolt to push the printed geometry outward thereby reducing the distortion (e.g., bow or warp) in the build plate so that the fastener between the build plate and the support structure may be removed.

### BRIEF DESCRIPTION OF THE DRAWINGS

Exemplary embodiments are illustrated in the referenced figure of the drawing. It is intended that the embodiment and figure disclosed herein to be illustrative rather than limiting.

FIG. 1 is a schematic of an exemplary laser powder bed fusion additive manufacturing process.

FIG. 2 is a perspective view of build plate with an article of manufacture positioned thereon.

FIG. 3 is a perspective view corresponding to FIG. 2 with the article of manufacture removed.

FIG. 4 is a perspective view of a removal apparatus position on a build plate and support structure according to an embodiment of the present disclosure.

FIG. 5 is a top plan view of the removal apparatus of FIG. 4.

FIG. 6 is a side view of the removal apparatus of FIG. 4.

FIG. 7 is a cross-sectional view of the removal apparatus of FIG. 4.

Several embodiments will be described more fully in reference to the accompanying figure. However, this disclosure should not be construed as limited to the embodiments set forth herein. Rather, these embodiments are provided so that this disclosure will be thorough and complete, and will fully convey the scope of the invention to those skilled in the art. In the drawing, like numbers refer to like elements throughout. Thicknesses and dimensions of some components may be exaggerated for clarity.

### DETAILED DESCRIPTION

The terminology used herein is for the purposed of describing particular embodiments only and is not intended to be limiting of the invention. As used herein, the singular forms “a,” “and,” and “the” are intended to include the plural forms as well, unless the context clearly indicates otherwise.

It will be understood that when an element is referred to as being “attached,” “coupled” or “connected” to another element, it can be directly attached, coupled or connected to the other element or intervening elements may also be present. In contrast, when an element is referred to as being “directly attached,” “directly coupled” or “directly connected” to another element, there are no intervening elements present.

All patents, patent applications and publications referred to herein are incorporated by reference in their entirety. In case of a conflict in terminology, the present specification is controlling.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

Additive manufacturing (AM) is utilized to build a wide variety of articles of manufacture (i.e., work or build pieces) having various geometric shapes of varying complexity. These work or build pieces are typically printed via a three-dimensional (3-D) printer using computer aided design (CAD), computer hardware and software and various metal powders. Many of these techniques build the article of manufacture onto a build plate. There are a number of different additive manufacturing techniques. For example, one system utilizes one or more lasers which fuse metal powder particles together layer by layer. This is referred to laser powder bed fusion (LPBF).

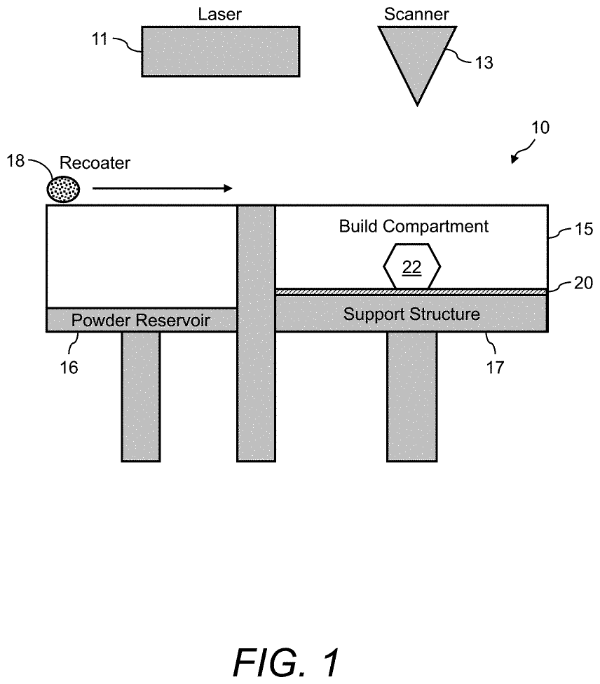

As shown in FIG. 1, the additive manufacturing system 10 may include a laser 11, a scanner 13 and a build compartment 15. Metal powder from a powder reservoir 16 is conveyed to the build compartment by a recoater 18. The recoater 18 typically includes a roller and a rake for moving the powder to the build compartment 15. The build compartment 15 includes a support structure 17 to which is mounted a build plate 20. The laser 11 via the scanner 13 melts the powder in the build compartment 15 based on data provided to the scanner related to the specifics of the part 22 being built. To build the part, after each layer of the part is built, another layer of powder is dispensed over the previous layer, which is subsequently fused by the laser. The resulting part 22 is cut from a build plate 20, allowing excess powder to fall away and be recycled. After each use or periodically, the build plate 20 may be depowdered, heat treated and/or planed to flatness. The build plate 20 overtime is subjected to distortion, namely warping and bowing caused by the heat of the additive manufacturing process and/or the weight of the part as it is formed on the build plate.

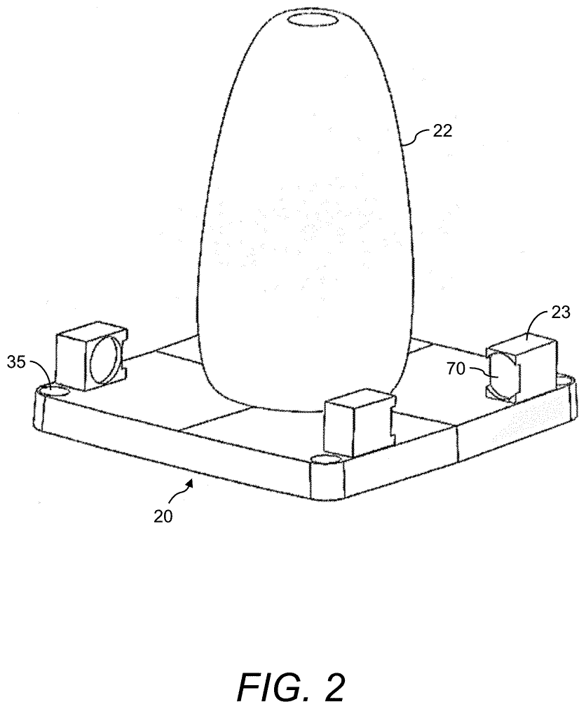

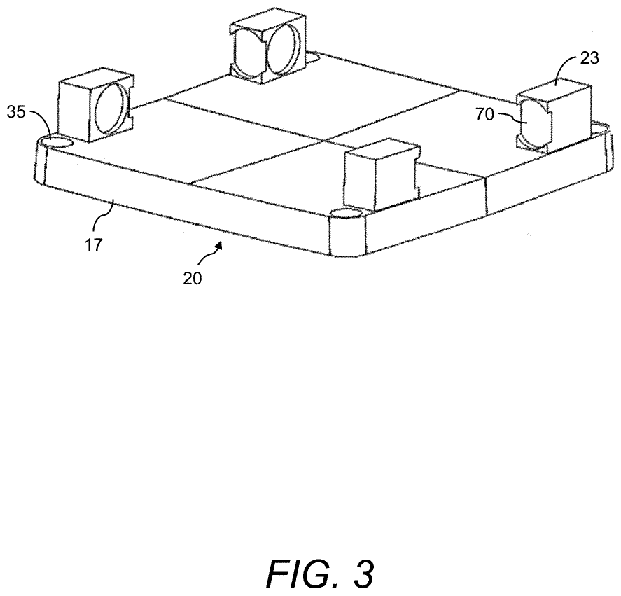

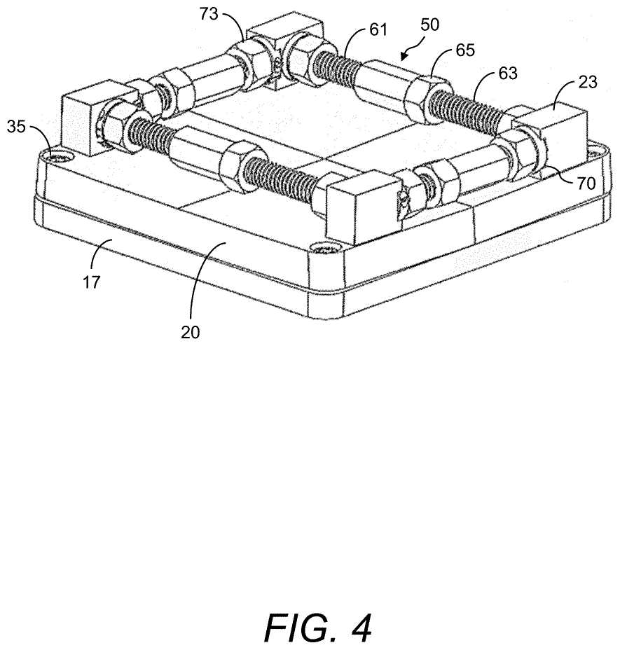

Referring to FIGS. 2 and 3, the build plate 20 after practice of the additive manufacturing process illustrated in FIG. 1 may have a part 22 and a plurality of printed geometrics 23 on the build plate 20. The heat of the additive manufacturing process and the size and weight of the part 22 (article of manufacture) may cause the build plate 20 to deform. As shown in FIG. 4, the build plate 20 may be attached to the support structure 17 using one or more fasteners 35. A plurality of the printed geometries 23 may be disposed proximate to the one or more fasteners 35, and the printed geometries 23 are part of the removal apparatus 25. As shown in FIGS. 2 and 3, the printed geometries 23 may be positioned proximate to the corners of the build plate 20. The printed geometries 23 are depicted as rectangular blocks but they may be of any geometry. The printed geometries 23 may be printed concurrently with the printing of the additive manufacturing part or article. In an alternative embodiment, the printed geometries 23 may be printed periodically at a predetermined number of work or build parts during the additive manufacturing process. The part 22 may be removed such as by using electrical discharge machining (EDM) leaving only the printed geometries on the build plate 20.

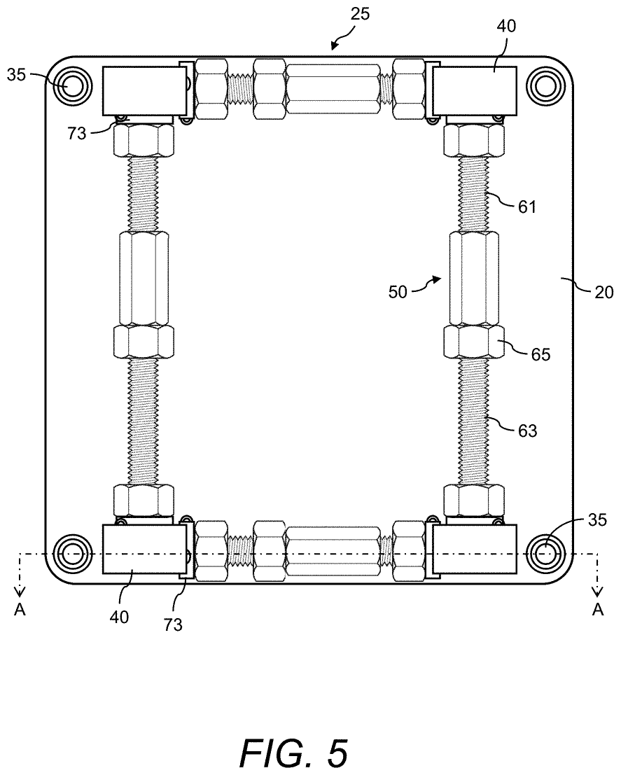

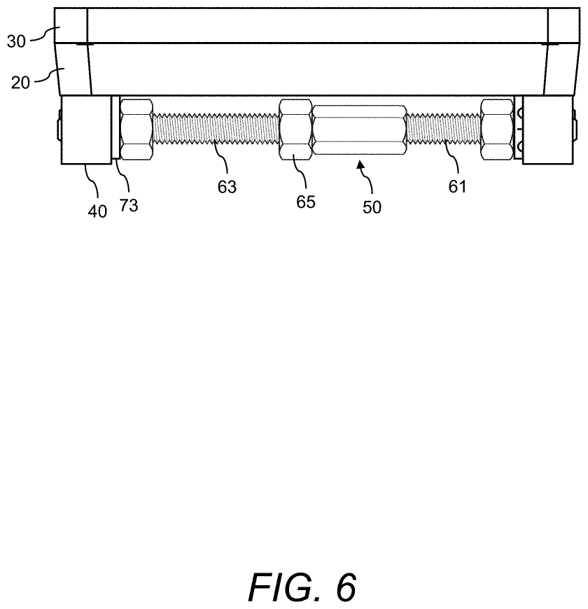

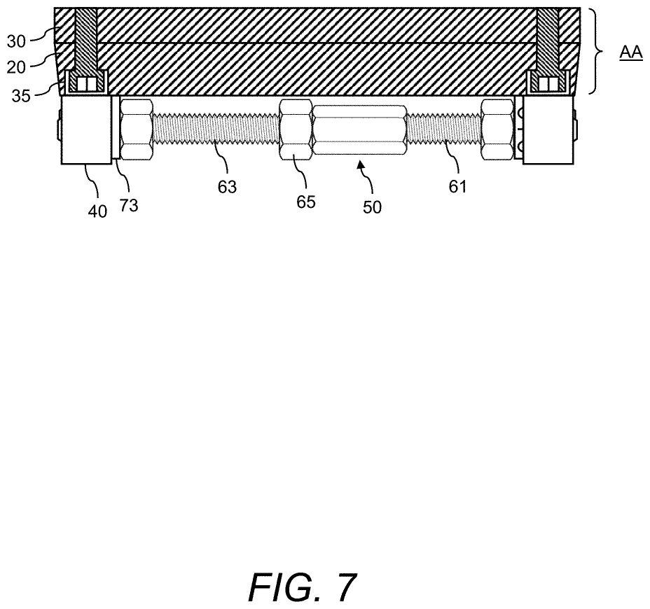

Referring to FIGS. 4-7, the removal apparatus 25 is shown positioned on the build plate 20, positioned on the support structure 17, and may include one or more expansion bolts 50. Each bolt 50 is sized for installation between the pair of printed geometries 23. The bolts 50 are configured to be expanded by a user to push the pair of printed geometries 23 apart from one another. The expansion bolts 50 may include a small lead screw 61, a large lead screw 63 and a coupling nut 65. Rotation of the coupling nut 65 in a first direction lengthens the expansion bolt 50 and rotation in a second direction shortens the expansion bolt 50. In order to facilitate the rotation of the lead screws 61, 63, the printed geometries 23 may include a recess 70 (See, FIGS. 2 and 3) and the expansion bolt 50 may include a foot 73 that is received in the printed geometry recess 70. The foot 73 as shown in the figures may be a clamping screw collar.

The present invention may also provide a method of removing an additive manufacturing build plate from a support structure. The method may include building a plurality of printed geometries on a distorted build plate utilizing additive manufacturing and proximate to one or more fasteners used to secure the build plate to the support structure. Once the printed geometries are built, one or more expansion bolts may be inserted into a recess of the printed geometries and placed between a pair of the printed geometries. Then the expansion bolts may be expanded to push the pair of printed geometries apart from one another to reduce the distortion of the build plate. This will facilitate the removal of the fasteners 35 so that the build plate 20 may be removed from the support structure 17. The plurality of printed geometries may be built simultaneously with building the part.

It will be understood that certain features and subcombinations are of utility and may be employed without reference to other features and subcombinations and are contemplated within the scope of the claims.

That which is claimed is:

1. A removal apparatus for aiding in the removal of an additive manufacturing build plate from a support structure, the removal apparatus comprising:
a plurality of printed geometries disposed proximate one or more fasteners used to secure the build plate to the support structure, wherein the printed geometries are printed concurrently with the additive manufacturing article;
one or more expansion bolts, wherein each bolt is sized for installation between a pair of the printed geometries and configured to be expanded by a user to push the pair of printed geometries apart from one another.

2. The apparatus of claim 1, wherein the expansion bolts comprise a small lead screw, a large lead screw, and a coupling nut, and further wherein rotation of the coupling nut in a first direction lengthens the expansion bolt, and rotation in an opposite second direction shortens the expansion bolt.

3. The apparatus of claim 2, further comprising a foot disposed at each end of the expansion bolt, wherein the foot is sized to be received by a recess in the printed geometries.

4. The apparatus of claim 3, wherein the foot comprises a clamping screw collar.

5. The apparatus of claim 1, wherein the additive manufacturing build plate is substantially rectangular in shape, and fasteners are disposed proximate the corners of the build plate.

6. A method of removing an additive manufacturing build plate from a support structure, the method comprising:
building a plurality of printed geometries on a distorted build plate utilizing additive manufacturing proximate to one or more fasteners used to secure the build plate to the support structure;
inserting one or more expansion bolts into a recess of the printed geometries and placed between a pair of the printed geometries; and,
expanding the expansion bolts to push the pair of printed geometries apart from one another to reduce the distortion of the build plate.

7. The method of claim 6, wherein the plurality of printed geometries are built simultaneously with building a part on the build plate.

8. The method of claim 7, wherein the expansion bolts are expanded by rotation of a coupling nut of the expansion bolt in a first direction to lengthen the expansion bolt.
